(19) United States
(12) Patent Application Publication
(10) Pub. No.: US 2008/0228844 A1
(43) Pub. Date: Sep. 18, 2008

(54) Method of Enhancing Spectral Data

(75) Inventors: Jean-Marc Bohlen, Cheseaux (CH); Edmund Halasz, Ecublens (CH)

Correspondence Address: HAYNES AND BOONE, LLP, 901 Main Street, Suite 3100, Dallas, TX, 75202, US

(73) Assignee: THERMO ELECTRON CORPORATION, Waltham, MA (US)

(21) Appl. No.: 10/598,359

(22) PCT Filed: Feb. 25, 2005
(86) PCT No.: PCT/EP2005/002114

§ 371 Date: Aug. 24, 2006

(30) Foreign Application Priority Data
Mar. 19, 2004 (GB) 0406246.9

(51) Int. Cl. G06F 17/14; G06E 1/04; G01J 3/28

(52) U.S. Cl. 708/191; 708/403

(57) ABSTRACT

A method of enhancing spectral data such as a frequency, wavelength or mass spectrum comprises applying an inverse Fourier Transform to the data in the frequency, wavelength or mass spectrum, zero-filling and, optionally, apodizing that inverse transform data, and then applying a Fourier Transform to convert the inverse data back into the frequency, wavelength or mass domain. The resultant processed spectrum provides a more accurate indication of peak location, shape and height.

### TECHNICAL FIELD

This invention relates to a method of enhancing spectral data such as, for example, optical spectral data and mass spectral data, obtained from a spectrometer.

### BACKGROUND TO THE INVENTION

Spectral data comprises a series of peaks and troughs which correspond to species or elements present within a sample (often graphically represented as a graph of intensity versus wavelength, frequency, energy or mass). For the case of optical emission spectra, a sample can be excited using various known techniques. The excitation causes the energy of atoms to be elevated to a higher energy level. As the atoms in the excited sample relax or decay to a lower energy level of excitation, photons are emitted having a discrete wavelength, thereby producing a series of sc-called spectral lines, each line corresponding to an energy transition. The energy, and hence wavelength, of the emitted photon is dependent on the energy gap between the excited and relaxed state of the atom, amongst other things. The energy levels and the gap between excited and relaxed states are dependent on the atomic element being excited. Thus, it is possible to deduce the constituent elements in a sample by looking at the wavelengths of optical emissions from an excited sample.

A typical arrangement for a spectrometer of this kind is shown in FIG. 1, which shows, highly schematically, a spectrometer 10 such as the ARL QUANTRIS™ spectrometer manufactured by Thermo Electron Corporation. Here, an excited sample S emits radiation 12 which comprises many spectral lines. Optical objectives 14, 16 and 18 respectively, each sample a portion of the radiation into the spectrometer. The radiation passes through entrance slits 20, 22, and 24 respectively. The sampled radiation then impinges on wavelength dispersing elements 26, 28 and 30 respectively. In this arrangement, the elements are reflection gratings, known in the spectrometer art although other types of dispersing elements can be used. Each grating determines the wavelength of radiation which is reflected onto detector arrays 32, 34 and 36 respectively, disposed in the focal plane of the grating 26, 28 and 30 respectively.

Modern optical spectrometers such as the spectrometer 10 of FIG. 1 use solid-state detectors, such as CCD (Charge Coupled Device) or CID (Charge Injected Device) which comprise at least one array of photo-detectors arranged downstream of a wavelength dispersing element and radiation source containing the excited sample. The array is mounted in the focal plane of the dispersing element. Because each detector has a finite physical width, each detector detects a band of wavelengths which is dependent on the width of each detector element, the dispersive power of the dispersing element, and the distance between the detector and dispersing element, among other factors. As a result, the resolving power of the spectrometer is limited by the number of detectors in the array and by the bandwidth of each detector.

Referring to FIG. 2, a typical spectrum 50 recorded with the ARL QUANTRIS™ spectrometer is shown. The spectrum is a graphical representation of the recorded radiation intensity 52 (in arbitrary units) as a function of wavelength 54 (measured in nanometers). The sample used to create this spectrum is composed of pure iron. As can be seen, the spectrum is very complex with more than 6000 spectral lines being visible on a 8640 pixel CCD array. A spectrum from a multi-element sample can be more complex still, depending on the concentration levels of the elements that compose the sample.

FIG. 3 shows a portion of the spectrum of FIG. 2, which is presented as a bar graph 60 of the signal detected by each individual detector element. The graph clearly shows that the resolution of the detected wavelengths is limited by the size or resolving power of the detector array. Each detector element effectively has a width over which it integrates the radiation incident upon it, creating a small wavelength pass band. The size of this pass band (usually quoted in picometers wavelength) depends, amongst other things, on the physical size of the pixel detector.

Several line types appear in FIG. 3: a single line 62 in the middle, with a FWHM (Full Width at Half Maximum) of roughly 2-3 pixels or detector elements; two overlapped lines, 64 and 66 respectively, to the left; and an unresolved group of peaks 68 to the right. The single line 62 is not centered on a pixel so that it is difficult to determine accurately where the centre of the line is. Not knowing the central position of the line, together with having too few digital measurements across the line, makes calculating the intensity of the line difficult, and hence deducing the quantity of the element that produced the line is also difficult.

Present methods which might increase the peak positioning accuracy, in most of the cases, use fitting techniques. Fitting techniques, such as Gaussian, Lorentzian and polynomial (parabolic) fits have proved unsatisfactory mainly because these techniques are not able to provide sufficient accuracy of the peak wavelength of a spectral line. Inaccuracy on the peak wavelength is typically observed when the peak shape is not ideal, for instance asymmetrical or due to overlap with one or several other spectral peaks. Also, such techniques do not allow accurate measurement of the peak intensity, and hence element concentration in the sample. Using such fitting techniques to calculate spectral line characteristics (such as line maximum position, maximum intensity and peak width, for instance) requires the raw data to ideally have a perfect shape, that is the line should be symmetrical, free from interference (which might be caused by proximate spectral lines causing overlap), and have a profile corresponding to the fitting curve (Gaussian profile if a Gaussian fit is being used) for an accurate fit to be performed. It is highly unlikely that these conditions will ever be realised in real spectral data, for instance distortions in line shape may occur due to optical or instrument aberrations, spectral line overlap, doublet interferences for example. As a result, improvement of the spectral line shape is often not satisfactory using these known techniques.

The problems outlined above limit the performance of optical emission spectrometers, as well as other kinds of spectrometers, for a given cost.

### SUMMARY OF THE INVENTION

It is desirable to increase the digital resolution in an attempt to resolve the problems discussed above. Additional improvements to spectra are also desirable, such as improvements to the signal to noise ratio, and signal interpolation.

Against this background, the present invention provides a method of enhancing spectral data, said data comprising M discrete intensity values within a range of wavelength, frequency or mass values,

said method comprising:

a) applying a first function to the spectral data to obtain an inverse transform of the spectrum,

b) zero-filling said inverse transform, and

c) applying a second function to the zero-filled inverse transform to obtain a spectrum comprising N discrete intensity values within said range of wavelength, frequency or mass values, and wherein N>M.

In embodiments of the present invention, a spectrum is measured in the wavelength, frequency or mass domain (or any other related domain such as but not limited to energy), and an inverse Fourier Transform (for example) is applied to the data to give a spectrum in the inverse transform domain. In the case of spectra which comprise a plot of intensity against wavelength or frequency, this inverse transform domain is a pseudo-time domain. Zero-filling and, optionally, apodization, and then a Fourier Transform is applied to this pseudo-time domain data to obtain an enhanced spectrum in the inverse frequency (wavelength) domain. In the case of a mass spectrum, the inverse transform domain is not analogous to the time domain but the technique can nevertheless be applied equally to it. In other words, following Zero-filling and, optionally, apodization, the mass spectrum can be reconstituted from the thus modified data in the inverse transform domain, by applying a second function such as a Fourier Transform to it.

The overall resolution of a spectrometer is a combination of the digital and the spectral resolution thereof. Here, the term “digital resolution” is employed to describe the resolution of the signal limited by the wavelength or frequency interval, or the mass interval, between two discrete consecutive values. In a raw spectrum, the digital resolution is thus limited by the bandwidth of the pixel and (for some detectors) the dead space between pixels. The term “spectral resolution”, by contrast, describes the optical or mass resolution limits of the optical or ion optical components prior to the detector, which may include an entrance slit and the dispersive element, for example. These two resolution limits are combined when the spectrum is measured and the combination of the two results in a resolution lower than each individual resolution.

The present invention addresses the digital resolution of the spectrometer (the spectral resolution being determined by the arrangement and components of the spectrometer itself). By manipulating the spectral data in the time domain, rather than seeking to interpolate the “raw” spectrum (that is, the data in the frequency/wavelength/mass/energy etc domain), several advantages accrue. For example, the location of the peaks (both in terms of intensity and in terms of wavelength or other spatial position) can be determined more accurately. Integration limits can be set with far greater precision. Drift compensation (that is, the drift of the spectrometer with time as a result of temperature changes etc) can also be applied more precisely.

The first function can be a Fourier Transform function which produces an inverse Fourier Transform of the spectral data. When the spectral data is a wavelength spectrum then the inverse transform is of a time-domain interferogram type. In other words, the spectrum can be transformed into a time-domain-like acquisition by inverse Fourier Transform or any transform producing a comparable effect.

Preferably, the first function is an inverse Fourier Transform (IFT). Again when the acquired spectral data contains intensity as a function of wavelength, applying such an IFT to the spectrum transforms it into a time-domain like acquisition, hereafter referred to as pseudo-time domain signal or interferogram. This interferogram is somewhat analogous to acquired signals from known Fourier Transform (FT) instruments (for instance Fourier Transform-Nuclear Magnetic Resonance (FT-NMR), Fourier Transform Ion Cyclotron Resonance Mass Spectrometry (FT-ICR), Fourier Transform Mass Spectrometry (FT MS), Fourier Transform-Infrared (FT-IR), and so forth). The skilled person will of course understand that, in the case of FT-MS and the like, the signals are acquired directly in the (true) time domain and are then transformed using an FFT into the frequency domain and from there (usually) into a mass or other spectrum—no inverse transform takes place.

The second transform stage is a transform function, the reciprocal of the first function, which transforms the signal back to the spectral representation of the signal. Other functions (and their reciprocal functions) might also be used to produce similar transformations (for instance z-transform, Hadamard transform).

Preferably, the invention further comprises the step of apodizing said zero-filled inverse transform prior to applying the second function. The second function can be applied to the apodized zero-filled inverse transform. Apodization can be used to improve signal-to-noise ratios of the enhanced data.

Furthermore, when the inverse transform is zero-filled by a factor Z, N is Z times greater than M. Preferably, Z should be in the range of 2 to 10. When Z is greater than 10, there is a burden on computing the enhanced data. Of course, as computational methods advance, values of Z>10 may be used to great effect. The ceiling value for Z of 10 is not considered limiting, and higher values might be used without leaving the scope of the invention.

The present invention also provides a computer program, which when run on a computer, carries out the method steps described above.

Furthermore, the present invention provides a processor configured (a) to receive spectral data from a spectrometer, the spectral data comprising M discrete intensity values within one of a range of wavelength values, a range of frequency values and a range of mass values; (b) to apply a first function to the spectral data to obtain an inverse transform of the spectrum, (c) to zero-fill said inverse transform, and (d) to apply a second function to the zero-filled inverse transform to obtain a spectrum comprising N discrete intensity values within said one of said ranges of wavelength, frequency and mass values, and wherein N>M.

The invention may also extend to a spectrometer arranged to generate an array of spectral data comprising M discrete intensity values within one of a range of wavelength values, a range of frequency values and a range of mass values, the spectrometer including such a processor.

In summary, embodiments of the present invention provide some or all of the following advantages:

(A) Peak position accuracy and precision is improved allowing correct identification of spectral lines and/or accurate and precise calibration of the spectrometer;
(B) The ability to reveal detailed features of the optical spectrum obscured by the limited digital resolution;
(C) Improved accuracy and precision of quantified spectral features such as peak height and/or peak area (setting the integration limits);
(D) More successful drift compensation, drift being caused by optical components shifting due to temperature changes, and/or the source position shifting due to argon gas pressure changes within the source chamber;
(E) Increased speed of analysis of sequential spectrometer instruments;
(F) Reduced array size for the detector, reducing cost;
(G) Ease of applying methods of improving the signal to noise ratio; and
(F) Ability to apply the method retrospectively to spectra taken before the ideas set out herein were developed, or before the most recent large array detectors were available

### DESCRIPTION OF THE DRAWINGS

An embodiment of the present invention is now described, by way of example, with reference to the following drawings, in which:

FIG. 1 shows a schematic diagram of a known optical emission spectrometer;

FIG. 2 shows a portion of an optical emission line spectrum for Fe;

FIG. 3 shows a portion of the spectrum of FIG. 2;

FIG. 4 shows the data from FIG. 3 after shifted IFFT function has been imposed on the data;

FIG. 5 shows raw data obtained from an optical emission spectrometer;

FIG. 6 shows the data of FIG. 5 once it has been enhanced according to a first embodiment of the present invention;

FIG. 7 shows the data of FIG. 5 once it has been enhanced according to another embodiment of the present invention;

FIG. 8 shows the data of FIG. 5 once it has been enhanced according to a further embodiment of the present invention;

FIG. 9 shows another data set representing raw spectral data;

FIGS. 10 and 11 show the data set of FIG. 9 after linear interpolation has been performed;

FIGS. 12 and 13 show the data set of FIG. 9 after functions according to embodiments of the invention have been performed;

FIG. 14 is a plot of the data of FIGS. 11 and 13 superimposed on the same graph;

FIG. 15 is a plot showing various different apodization functions which can be applied to data;

FIG. 16 is a plot of raw data obtained from a pure aluminium sample;

FIG. 17 shows the data of FIG. 16 after a method embodying the present invention has been applied without apodization;

FIG. 18 shows the data of FIG. 16 after a method embodying the present invention has been applied with apodization;

FIG. 19a shows a raw mass spectrum, with the intensity and mass axes both shown on a linear scale;

FIG. 19b shows the raw mass spectrum of FIG. 19a, with the intensity axis on a logarithmic scale but with the mass axis on a linear scale;

FIG. 20a shows the data of FIGS. 19a and 19b after a method embodying the present invention has been applied without apodization, and with the intensity and mass axes both shown on a linear scale;

FIG. 20b shows the mass spectrum of FIG. 20a, with the intensity axis on a logarithmic scale but with the mass axis on a linear scale;

FIG. 21a shows the data of FIGS. 19a and 19b after a method embodying the present invention has been applied with apodization and with the intensity and mass axes both shown on a linear scale; and

FIG. 21b shows the mass spectrum of FIG. 21a, with the intensity axis on a logarithmic scale but with the mass axis on a linear scale.

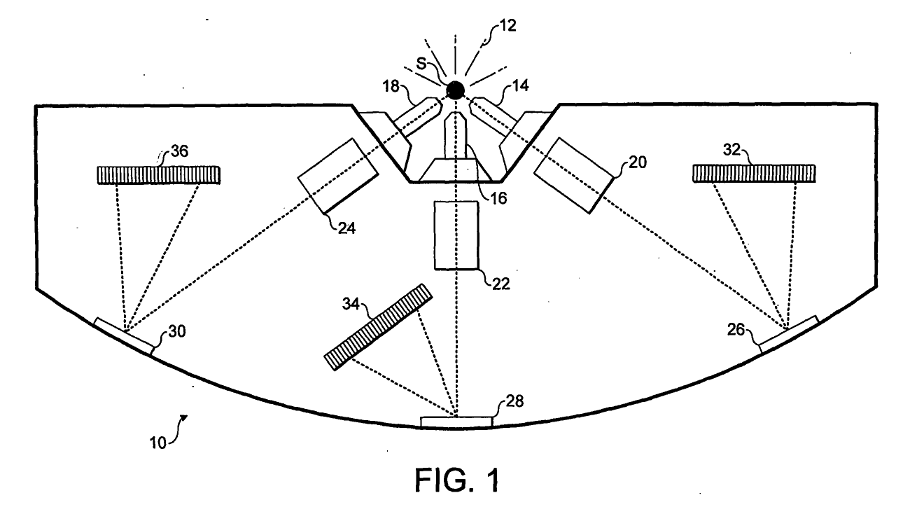

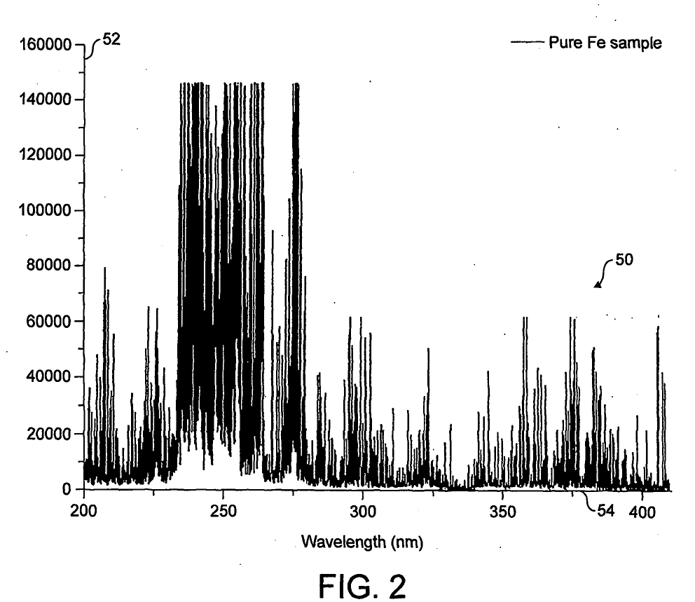

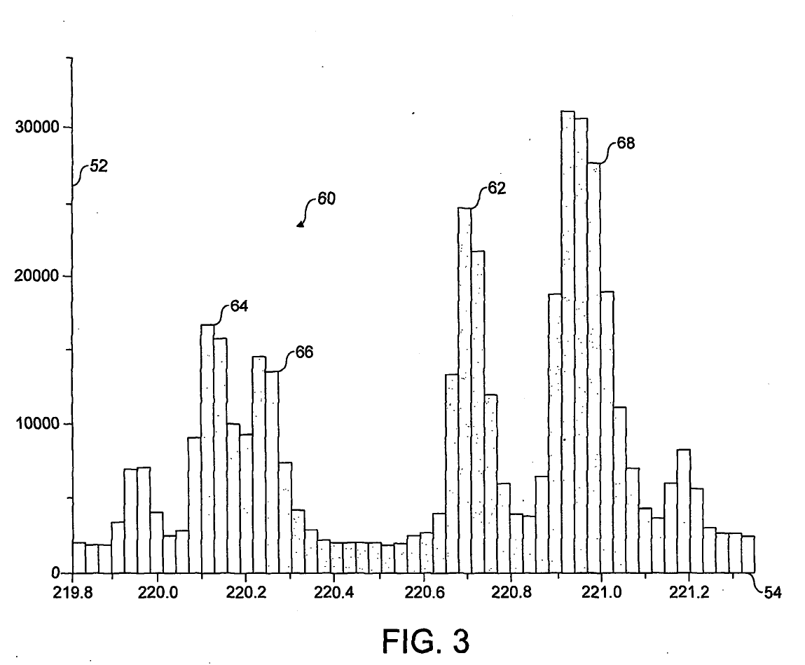

### DETAILED DESCRIPTION OF EMBODIMENTS OF THE PRESENT INVENTION

An embodiment of the present invention comprises a method of manipulating digitised spectral data which can produce a resultant spectrum that more accurately resembles the physical spectrum emitted from the sample. In other words, the enhanced/manipulated spectral data more closely correlates with the actual spectrum emitted by the sample.

The method comprises steps, some of which are not essential, which should be carried out on the digital spectral data, as follows.

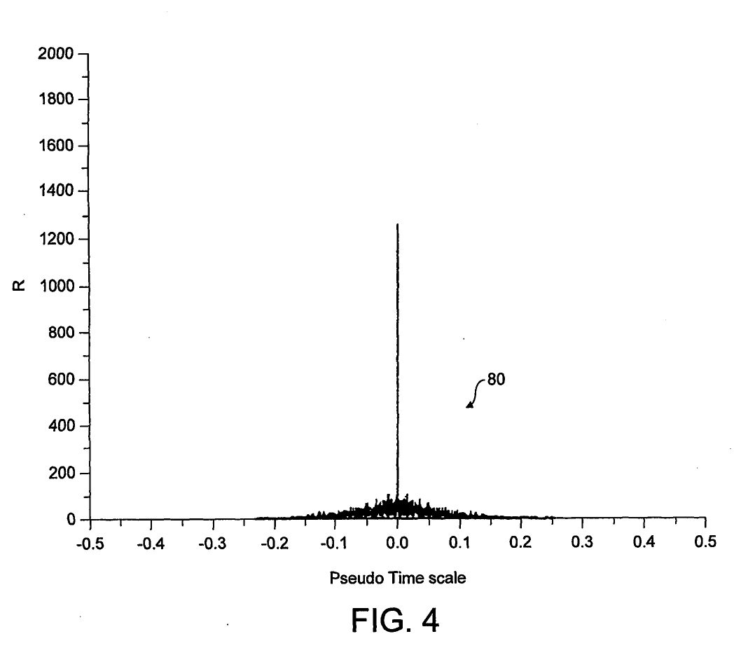

Step 1: To a raw spectrum (spectral or frequency-domain) defined by a set of 2^{m} pixels (where m is an integer number), apply an Inverse Fast Fourier Transform (IFFT). 2^{m} data points are required for applying Inverse Fast Fourier Transform algorithm. (A shifted IFFT provides a result as a symmetrical pseudo-interferogram; all computations are more elegant due to the symmetry). An “interferogram” type data set is obtained, in a ‘pseudo’-time domain. The interferogram has M=2^{m} (un-shifted IFFT) or 2^{m}+1 (shifted IFFT) data points, depending on the way the dataset is handled. Such an interferogram 80 is shown in FIG. 4. In this case, it has 2^{m}+1 data points, it is symmetrical about time t=0 and has the time scale normalized to 1 seconds, from −0.5 to +0.5 seconds.

Step 2: Zero-fill the interferogram thus adding 2ⁿ−2^{m} data points with intensity equal to zero. This increases the number of data points to 2ⁿ+1 where n>m. The number 2^{(n-m)} gives the degree of Zero-filling. Zero-filling is a technique by which zero values are added (symmetrically only for the shifted IFFT) to the real and the imaginary part of the IFFT for the new data points. In other words, the IFFT data between −0.5 and 0.5 on the pseudo-time scale remains unchanged and data with a value of zero is added to the IFFT between values of −1.0 to −0.5 and 0.5 to 1 (in this case where the time scale is enlarged by a factor of 2, the degree of zero-filling is 2).

Step 3: (optional, non-essential step) apply apodization to the interferogram. Apodization is a multiplication of the imaginary and real part of the IFFT interferogram with a selected function in order to improve either the signal-to-noise ratio (equivalent to smoothing), to the detriment of resolution, or to improve spectral resolution to the detriment of the signal-to-noise ratio. Examples of apodization are discussed below.

Step 4: apply a Fast Fourier Transform (FFT) to the results of steps 2 (or step 3, if used). The obtained spectrum has 2ⁿ points.

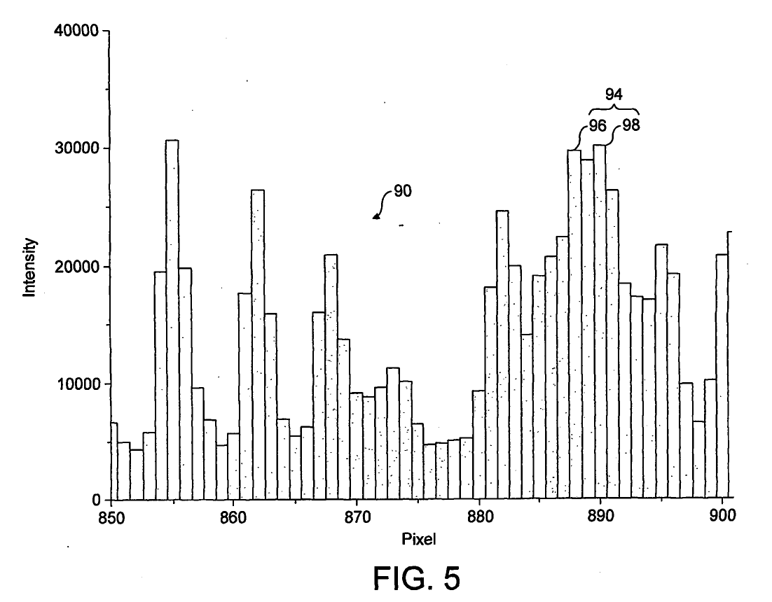

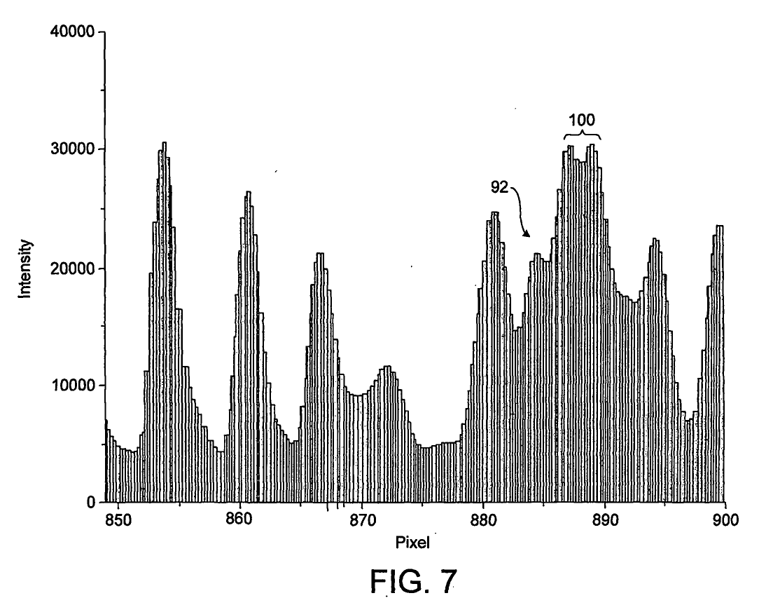

As an example, FIGS. 5, 6, 7 and 8 show the effect of zero-filling to various degrees on an inverse Fourier Transform of a raw optical emission spectrum, followed by the FFT back to the wavelength domain. No apodization (i.e. step 3 outlined above has not been performed) has been performed on the data in the example shown in these figures. The raw spectrum was recorded with spectrograph 2 of ARL QUANTRIS using a CrNi steel sample to produce a spectrum.

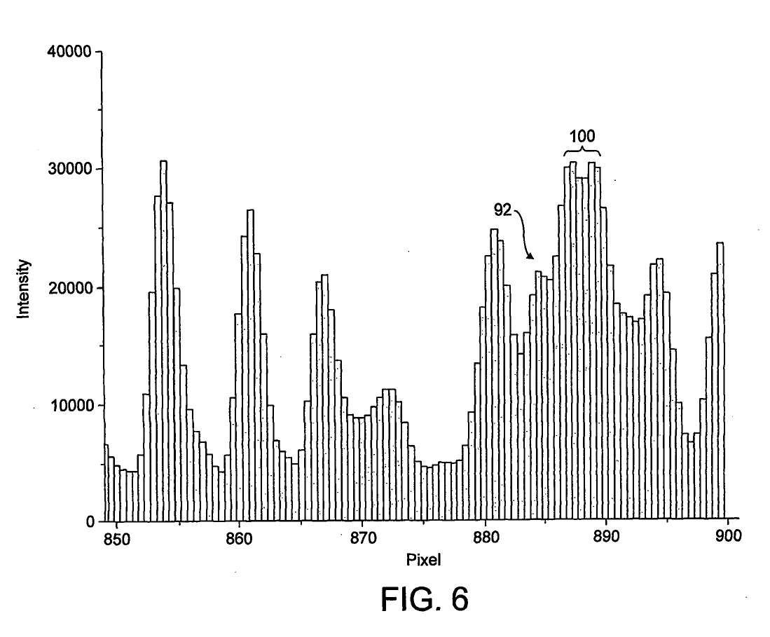

FIG. 5 shows the raw data 90, obtained from the spectrometer, plotted as a function of pixel number against an arbitrary intensity value; the pixel-limited digital resolution is evident. Three examples of zero-filling are presented in FIGS. 6, 7 and 8, where the factor of zero-filling used is 2, 4 and 8 respectively.

As can be seen, zero-filling alone does not change spectral resolution (and indeed cannot do so since this is determined by the optical arrangement of the spectrometer), but it does increase the digital resolution, and it also makes the shape of the peaks closer to the natural shape of the peaks (the manipulated data peaks having a “less-digitised look”). Minor details (previously hidden) are also unveiled, such as the peak indicated by numeral 92 in FIGS. 6, 7 and 8 which is not visible in the raw data. Furthermore, the raw data shows a spectral region 94 which comprises two adjacent spectral peaks 96, 98 of different intensity. However, the same region 100 in the manipulated/zero-filled data of FIG. 6, 7 or 8 shows two peaks with substantially the same intensity.

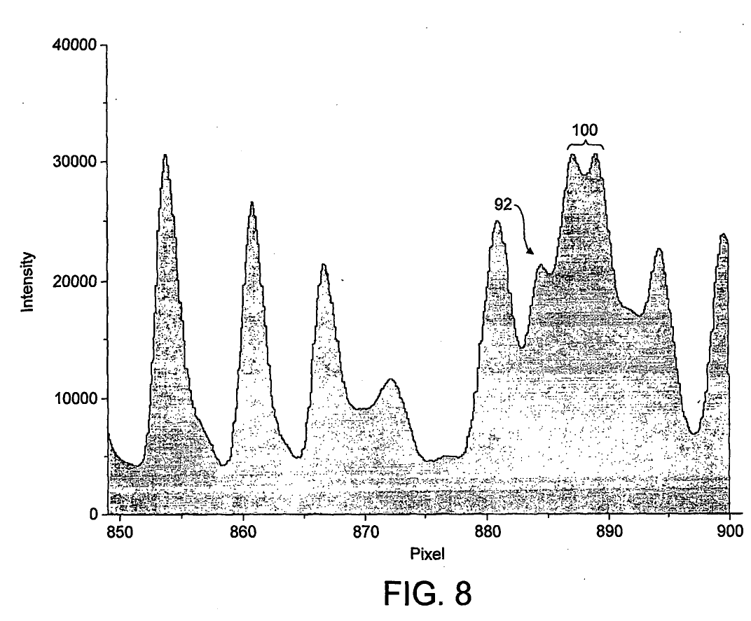

The resultant spectrum can be analysed to determine the peak position with an accuracy and precision which was previously not readily possible. Integration limits can be set with far greater precision (up to a factor 8 in the example shown in FIG. 8). Drift compensation can also be more precisely applied. This technique reduces the correction scale unit down to a logical pixel, instead of a physical pixel width.

Comparison of Data Fitted Using an Embodiment of the Present Invention with Known Techniques.

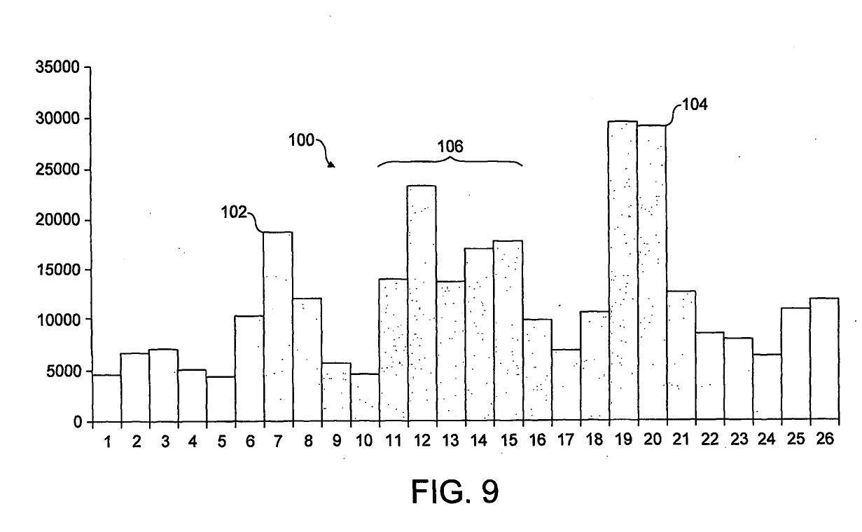

A comparison of data manipulated using an embodiment of the present invention with the technique of linear interpolation is now presented. FIG. 9 shows some raw spectral data 100 presented as a histogram chart. The data comprises of a selection of twenty-six data points plotted along the x-axis, each having different intensities which are represented by the height of each bar in the histogram, and which are plotted along the y-axis. It can be seen that the spectrum comprises two singlet peaks 102 and 104, and a doublet 106′. The first peak appears to have a FWHM value of between one and three pixel widths—it is certainly not possible to given an accurate estimation of the peak's FWHM value. Likewise with the other peaks shown in the spectrum.

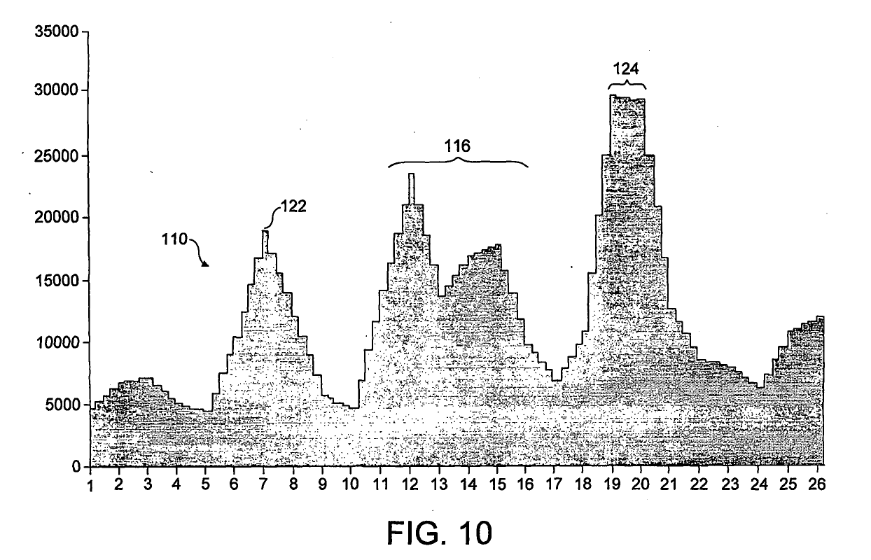

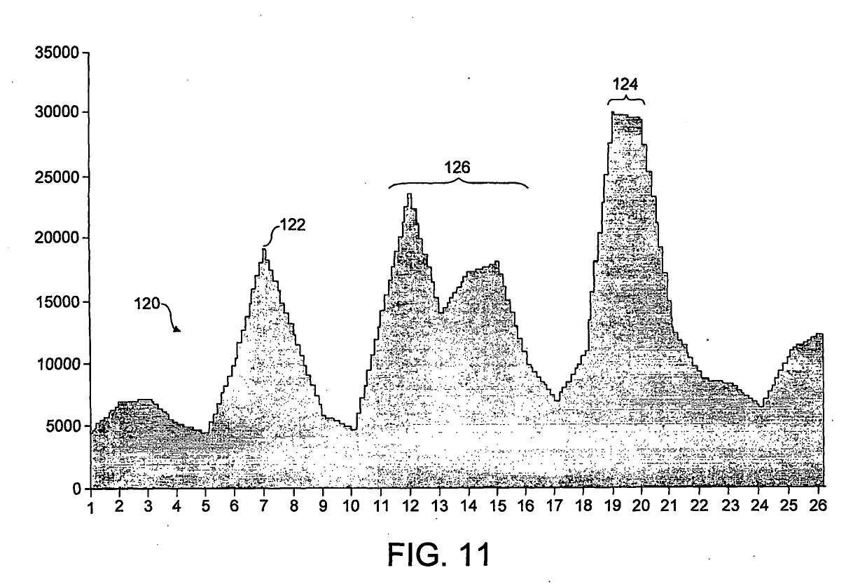

Referring to FIGS. 10 and 11, a plot of the spectral data 100 of FIG. 9 is shown after the data has been subjected to linear interpolation of a fourth and eighth degree respectively. Briefly, a straight line is plotted between two adjacent data points by plotting a number of contrived data points between real data points. If linear interpolation is carried out to two degrees, then two contrived data points are plotted between two adjacent real data points. Likewise if linear interpolation is carried out the eighth degree, then eight contrived data points are plotted between two adjacent real data points.

The results of linear interpolation plot 110 shown in FIGS. 10 and 11 are plotted as histogram charts. It can be seen that linear interpolation only goes a small way to improving the raw data. For instance, it is still difficult to ascertain exactly the centre of the second peak 114, or the centre of the second doublet peak 118. The situation is not improved by using a higher power linear interpolation plot 120 as shown in FIG. 11. By increasing the degree of interpolation it can be seen (from a comparison of FIGS. 10 and 11) that no great benefit is yielded for someone trying to determine the centre of peak 124, etc.: The centre of peak 124 appears to be in exactly the same position as the centre of peak 114.

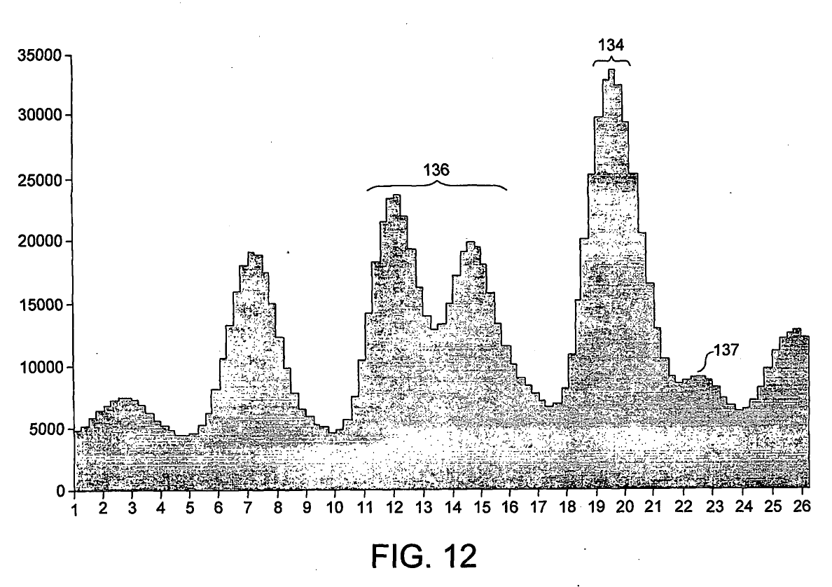

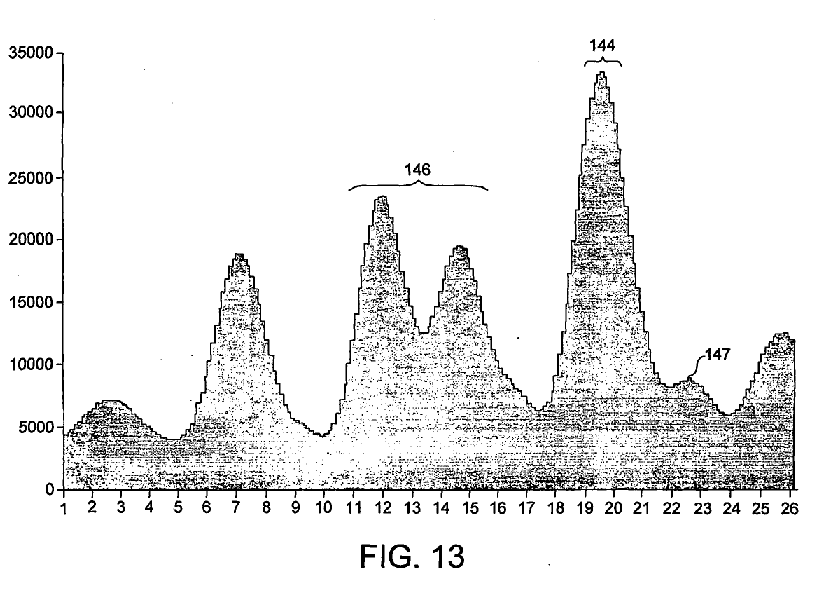

Referring now to FIGS. 12 and 13, a plot of the spectral data 100 of FIG. 9 is shown after the data has been subjected to manipulation according to an embodiment of the present invention of a fourth and eighth degree respectively without apodization. Once again, FIGS. 12 and 13 show a selection of a spectrum after manipulating all 8640 pixels in the spectrum, and not just the 26 pixels displayed.

From the resultant manipulated data shown in FIG. 12 and FIG. 13, it can be seen that it is much easier to discern details in the spectrum which were not otherwise apparent from either the raw data or the data which has undergone linear interpolation. For instance the centre of peak 134 and 144 can now be easily determined, compared to inadequate centre measurement of peaks 104, 114 or 124. Also, the shape of the doublet 136 and 146 is much better defined with respect to the raw data and data having linear interpolation performed thereon. Features in the zero-filled data appear which were not apparent from either the raw data or the linearly interpolated data. For instance, the peak indicated by numerals 137 and 147 is not entirely apparent in either the raw data or data on which linear interpolation has been performed.

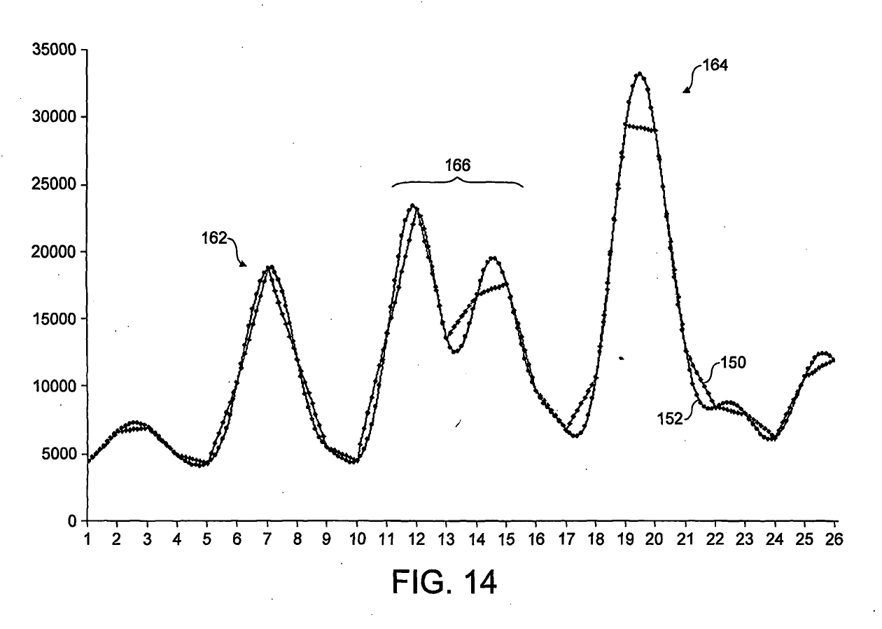

Referring now to FIG. 14, a direct comparison of the plots shown in FIGS. 11 and 13 is made. Here, the data from each of the respective data points is shown as a line plot, rather than a histogram. This makes the comparison easier to visualise. The data from FIG. 11 (that is, the linear interpolation to an eighth degree data) is indicated by line 150 (individual intensities represented by diamonds on line 150). The data from FIG. 13 (that is the zero-filled data according to an embodiment of the present invention) is indicated by line 152 (individual intensities represented by circles on line 152).

The singlet peak 162 on the left hand side of the spectrum shows relatively good correlation between the zero filled data and the linear interpolation data. The FWHM of both sets of data are similar and both sets of data show good correlation for the predicted centre wavelength of this peak. Also, the intensity of the peak 162 is similar for the linear interpolated and zero-filled data.

However, there are large differences in the characteristics of other peaks in the data which are readily apparent. For instance, the intensity of the peak 164 varies considerably between the two data sets. Likewise there is little correlation between the data sets with regards to the overall shape of the doublet 166, particularly the right-hand peak of the doublet. Also, the centre of the peaks is much clearer from the zero-filled data, particularly for the 164 peak. It is not at all clear from the linear interpolated data exactly where the centre of peak 164 lies. It would appear to be anywhere between pixel number 19 to 20 (on the x-axis). However, the zero-filled data shows a clear discernable peak at one value.

### Apodization

Apodization is a known method of further manipulating data to increase signal to noise ratio, to reduce artefacts, or to increase resolution. Essentially, apodization comprises imposing a function on the real and imaginary data of a time-domain signal. Depending on the apodization function chosen, the resultant data can be further enhanced when it is transformed back into the wavelength domain.

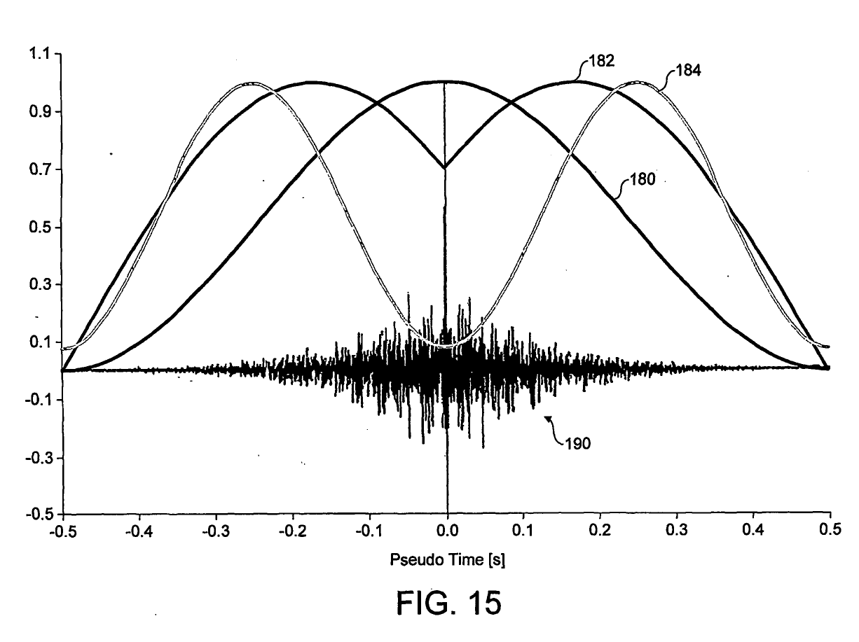

FIG. 15 shows various apodization functions: a so-called cosine square 180, a so-called shifted sine-bell 182 and a Hamming function 184. The cosine square function almost fits the signal 190 envelope which looks as a function centred at maximum, decaying monotonously towards the ends. The further the signal is from the centre of the graph, the more the intensity is reduced by multiplying by the function. The resultant signal envelope has a faster decay which corresponds in the spectral domain to a broader FWHM. Noise being constant over the interferogram, the part of the interferogram with the worst signal to noise ratio is given less weight. In other words, the signal to noise ratio is improved at the expense of spectral resolution. Other functions having a monotonous decay (for instance an exponential function) perform in a similar way to the cosine square function. A variety of other known functions can be used to improve the resolution, for instance a shifted sine-bell or a Hamming function. Usually these functions put less weight on the part of the interferogram 190 around time=0 s, than on the intermediate parts, for example, around times=±0.10-0.30 s.

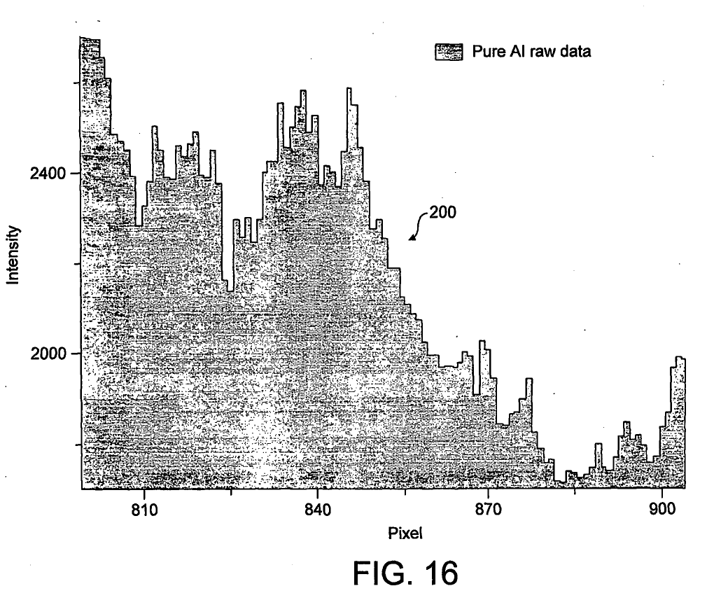

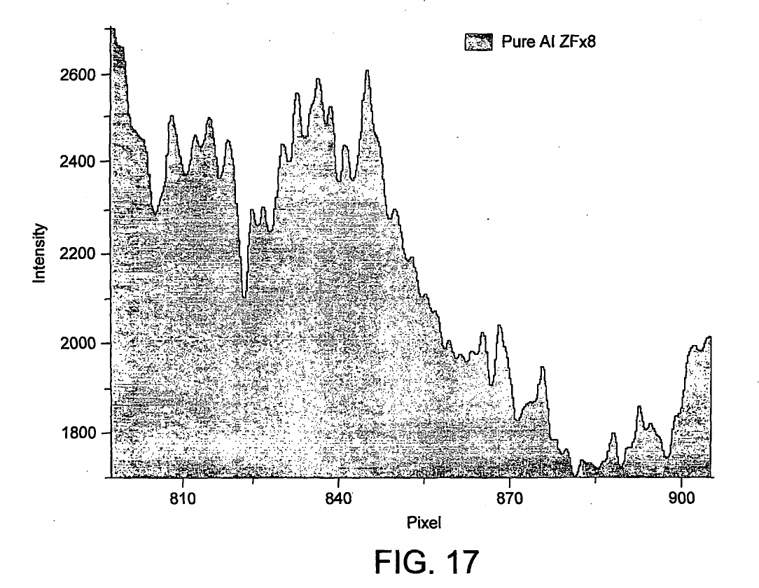

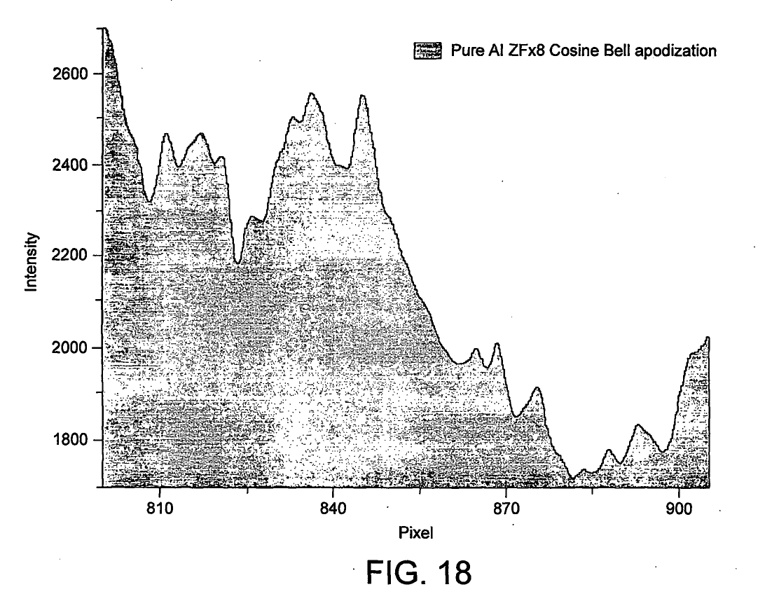

FIGS. 16, 17 and 18 show raw data, the effects of zero-filling only, and of apodization on a zero-filled spectrum, respectively. An Inverse Fast Fourier Transform is applied to the raw optical emission spectrum 200 (FIG. 16), followed by zero-filling (FIG. 17) and by zero-filling and apodization (FIG. 18). Finally a Fast Fourier Transform returns the data to the wavelength domain. In this example a pure Al sample spectrum is used. Using as an apodization function cos(t)² (so-called square cosine bell, 180 in FIG. 15) where t is the pseudo-time, a smoothing effect is obtained, as can be seen by comparing FIGS. 17 and 18. This smoothing is important for evaluating background regions and improving the signal-to-noise ratio for data at low concentration levels. It can be seen that the smoothing has improved the signal-to-noise ratio of the data set, but at the expense of spectral resolution; the line widths have increased. Other apodization functions are available that also improve the signal-to-noise ratio in this way. Normally these are functions that make the envelope of the pseudo-time signal shorter.

Improvements to the digital resolution are only worthwhile if the spectral resolution is greater than the digital resolution (since otherwise the former becomes the limiting factor). Apodization techniques can be used to improve digital resolution or reduce artefacts in cases where the pseudo-time domain data is truncated (i.e. has a significant intensity at the extremities). In such cases, after Zero-filling, Fourier Transforming the signal leads to artefacts in the structure of the peaks or lines. When the intensity range of the spectrum (i.e., the dynamic range) is large, the artefacts arising from the largest peaks may have intensities comparable to those of the smallest peaks. To avoid this, truncated signals in the pseudo-time domain can be apodized to more smoothly take the signal to zero. This apodization itself leads to line or peak broadening. To avoid this, linear prediction is applied to generate the additional data points required to take the pseudo-time signal to zero, without introducing the line broadening effects of the apodization function.

Embodiments of the present invention thus improve spectral details and resolution, allow the use of cheaper CCDs (possibly with fewer pixels than is presently required for necessary resolving powers) and/or to reduce the time taken to obtain accurate spectra. The time saving is particularly beneficial in sequential (scan) techniques.

Although the invention has been described in connection with optical emission spectra it will be understood that the techniques are equally applicable to other forms of spectra. By way of example only, methods embodying the present invention can be applied to other spectrometers which produce intensity versus wavelength measurements, such as Inductively Coupled Plasma-Optical Emission Spectroscopy, Energy Dispersive-X-Ray Fluorescence and Wavelength Dispersive-X-Ray Fluorescence.

The foregoing discusses the application of an inverse Fourier Transform to data in the frequency or wavelength domain, to produce a data set in what is referred to as the “pseudo-time domain”. It is this pseudo-time domain data that is apodized and/or zero filled, before transformation back into the wavelength/frequency domain. It is however to be understood that the method described is equally applicable to intensity data obtained as a function of mass (strictly, mass to charge ratio). Such data is routinely obtained from, for example, Inductively Coupled Plasma-Mass Spectrometry, Gas Chromatography-Mass Spectrometry, organic MS-MS, Time of Flight (TOF) MS, or triple quadrupole techniques using, for example, electro-spray sources.

In such cases, as with the intensity vs frequency/wavelength embodiments described above, an inverse Fast Fourier Transform is first generated. The data thus transformed (in what is referred to here as the inverse transform mass domain) is apodized and zero filled as previously and then an FFT is applied to the resultant data to convert it back into the mass domain.

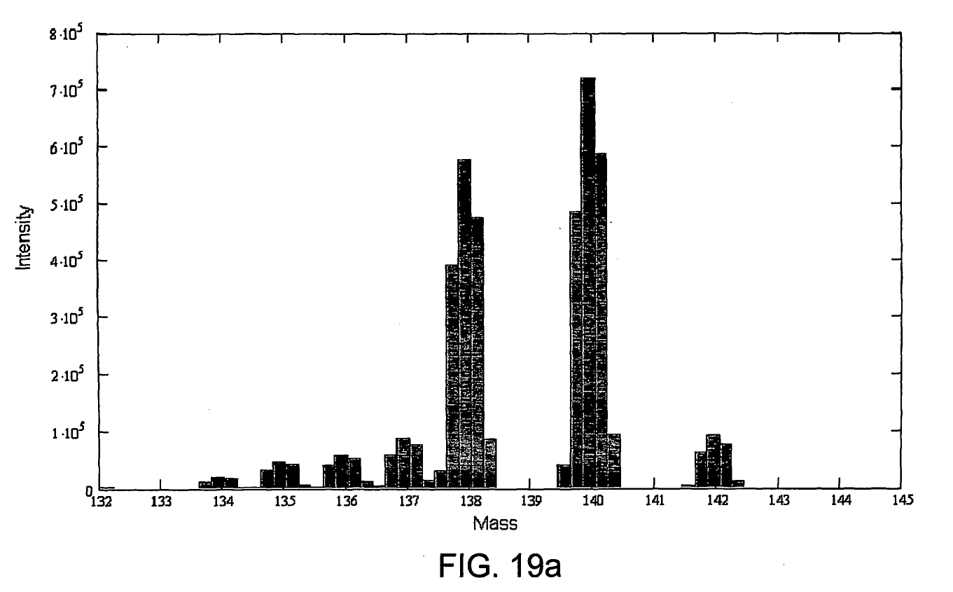

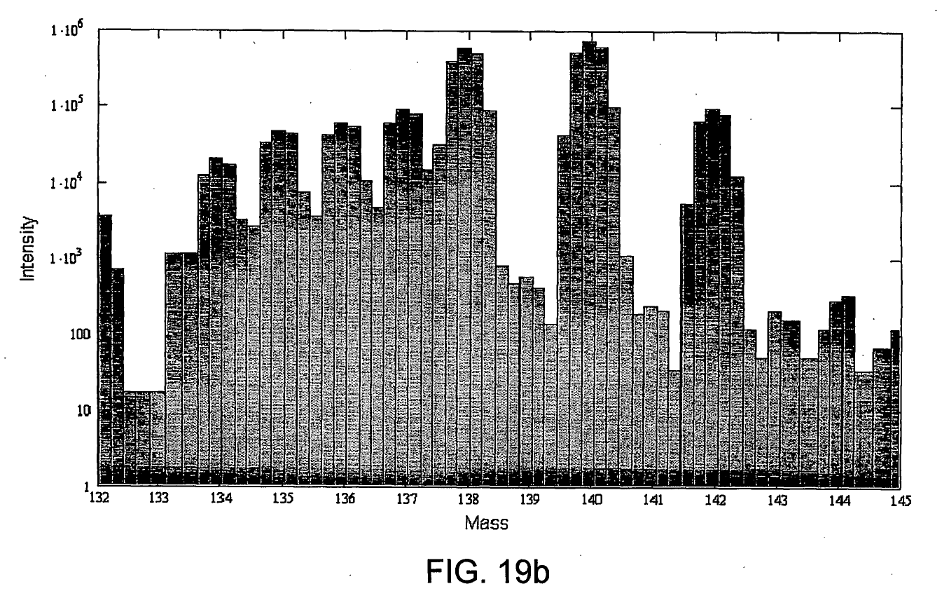

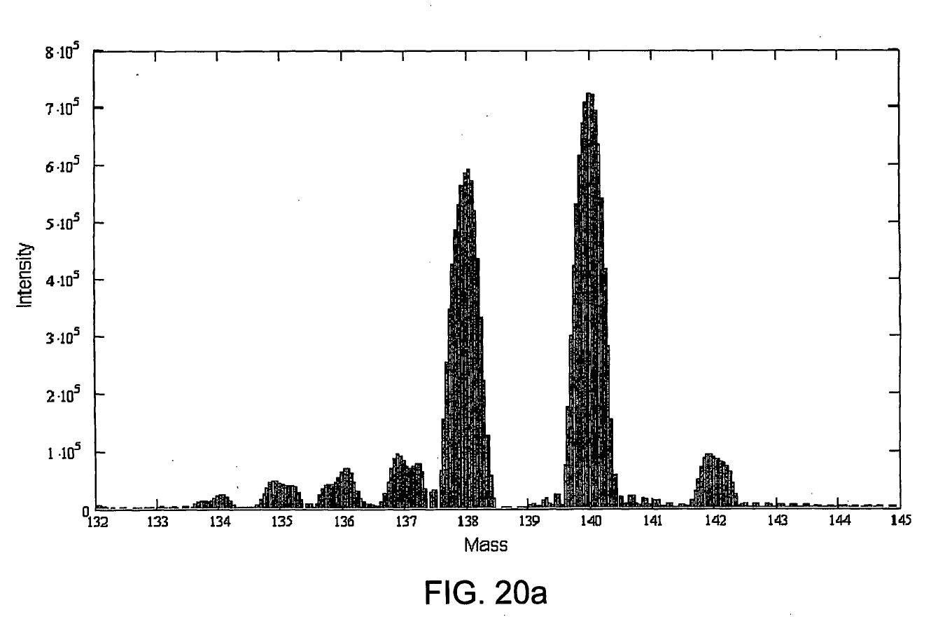

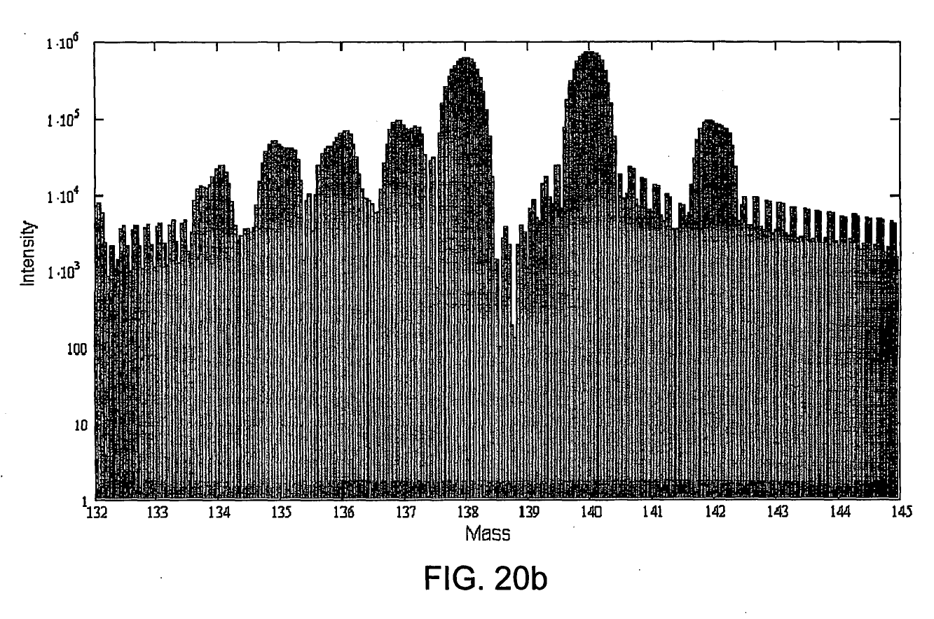

FIG. 19a shows a “raw” mass spectrum in the absence of any further processing, on linear vertical and horizontal scales, and FIG. 19b shows the same “raw” mass spectrum on a log-linear scale. FIG. 20a shows the same mass spectrum, again on a linear vertical and horizontal scale, but with the data post processed by applying an IFFT, Zero-filling to degree 4, and then applying an FFT to convert the data back into the mass domain. Finally FIG. 20b shows the processed mass spectrum of FIG. 20a but on a log linear scale.

Two features are notable: firstly, the peaks in FIGS. 20a and 20b are smoother than those in FIGS. 19a and 19b (exactly as with the earlier embodiments of FIGS. 16, 17 and 18), but secondly, a significant amount of artefacts are introduced away from the peaks, as is particularly apparent in the log linear plot of FIG. 20b. This is a consequence of the nature of the mass spectrum in FIGS. 19a and 19b, which each represent an elemental mass spectrum consisting of a relatively small number of peaks across the measured mass range, with a large range of intensity values (a high dynamic range). Artefacts due to the highest peaks are comparable to the smallest peaks of interest. Zero-filling in the regions that have no peaks leads to the artefacts seen best in FIG. 20b.

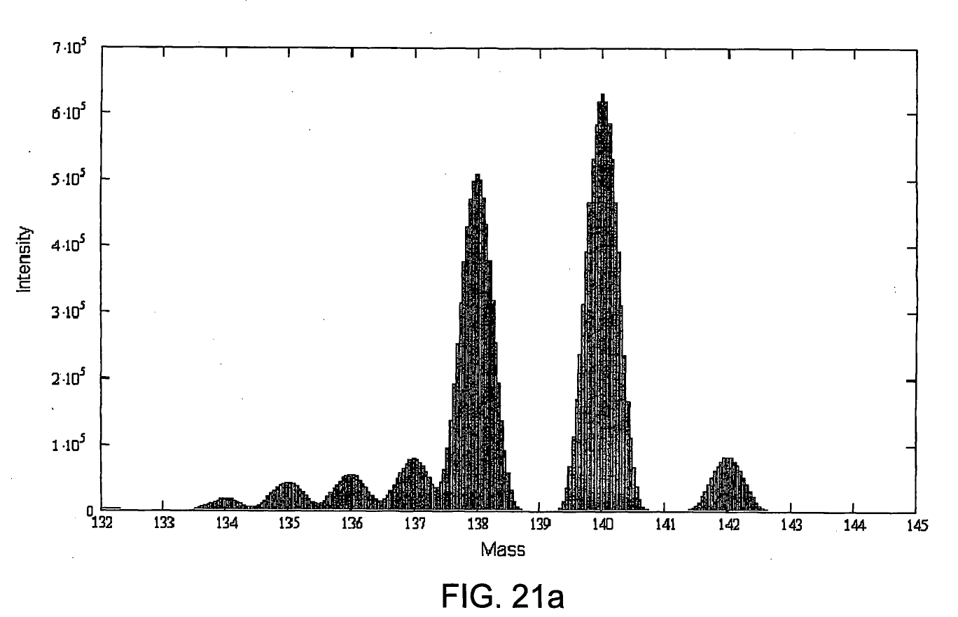

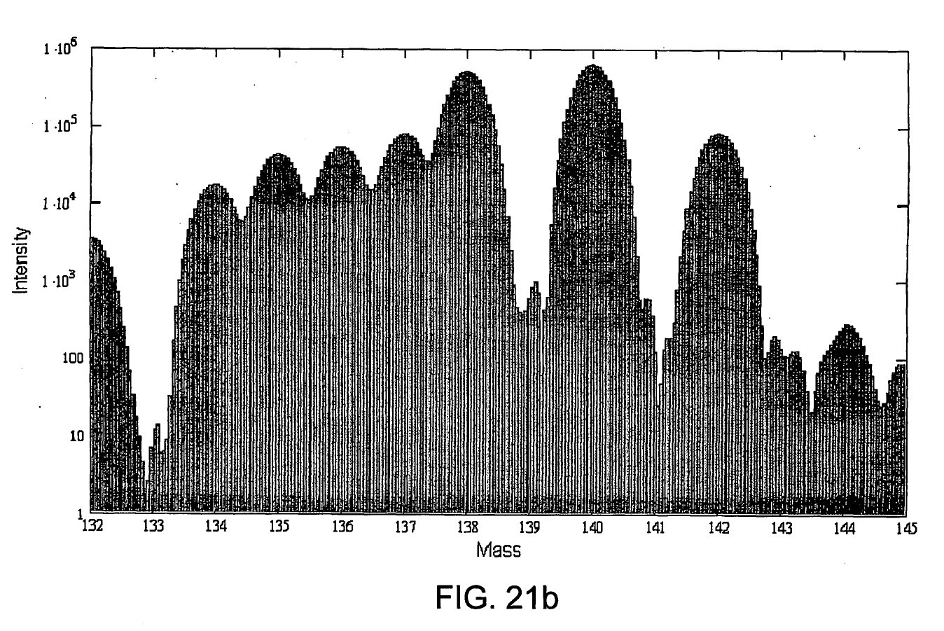

By apodizing the data in the inverse transform mass domain prior to Zero-filling, a good deal of these artefacts can be removed. FIGS. 21a and 21b show the same processed mass spectrum as in FIGS. 20a and 20b, but this time with a cosine squared apodization function applied to the “raw” data from the mass spectrum once an IFFT has been applied to it to transform it into the inverse transform mass domain. The apodization is applied before the subsequent Zero-filling takes place, again in the inverse transform mass domain, and then an FFT back to the mass domain occurs. It will be seen by comparison of FIGS. 20b and 21b in particular that the number of artefacts away from the peaks have been reduced. Apodization using the cosine squared function has slightly broadened the peaks and slightly reduced the peak height but the noise has almost completely been removed.

Apodization effectively acts to “weight” the Zero-filling preferentially around the peaks and so the choice of apodization function is dependent upon the spectral shape. Other functions might therefore be employed depending upon the anticipated nature of the mass spectrum. For example, whilst a cosine squared function appears to suit the concentrated peak profile of the elemental mass spectrum of FIGS. 19, 20 and 21, other functions might be even more appropriate, and for other types of mass spectrum, still other apodization functions might be more suitable. For example, in so called MS-MS or MSⁿ experiments carried out on organic molecules in triple quadrupole arrangements, a mass spectrum will often contain a continuous or almost continuous set of peaks over a selected mass range, as a result of the presence of multiple precursor and fragment ions. The technique described above is equally suitable to such spectra, and, due to the usual presence of a continuous or quasi continuous set of peaks over a mass range with a relatively modest intensity (or dynamic) range, Zero-filling alone may produce a processed mass spectrum without significant noise added.

In addition to ICP-MS and triple quadrupole applications, the skilled person will appreciate that the technique is equally applicable to mass spectra produced from still other mass spectrometer arrangements, including but not limited to magnetic sector devices, 3-dimensional traps, time of flight (TOF) devices and the like.

Moreover, imaging spectroscopes such as ICP-CID spectra (with a bi-dimensional FFT processing) can be treated by methods of this present invention.

Furthermore, it can be applied to spectra that have been recorded by sequential spectrometers. In such cases, it can save important scanning time (and costs) by increasing the scan step size by a factor of two or four, without prejudice to the final spectrum.

1. A method of enhancing spectral data, said data comprising M discrete intensity values within one of a range of wavelength values, a range of frequency values and a range of mass values, said method comprising:
a) applying a first function to the spectral data to obtain an inverse transform of the spectrum,
b) zero-filling said inverse transform, and
c) applying a second function to the zero-filled inverse transform to obtain a spectrum comprising N discrete intensity values within said range of wavelength, frequency or mass values, wherein N>M.

2. A method according to claim 1, further comprising the step of:
i) apodizing said inverse transform, before zero-filling and applying the second function.

3. A method according to claim 2, wherein the second function is applied to the apodized zero-filled inverse transform.

4. A method according to claim 1 or 2, wherein when the inverse transform is zero-filled by a factor Z, and wherein N is Z times greater than M.

5. A method according to any preceding claim, wherein the spectral data comprises an atomic emission spectrum.

6. A method according to claim 1, 2 or 5, wherein the spectral data is in the ultra-violet, visible and/or infrared domain.

7. A method according to any of claims 1 to 4, wherein the spectral data comprises a mass spectrum.

8. A method according to any preceding claim, wherein the first function is a Fourier Transform function and second function is an inverse Fourier Transform function.

9. A method according to any preceding claim, wherein the spectral data and the spectrum are a spectrum in the frequency domain.

10. A computer program, which when run on a computer, carries out the method according to any preceding claim.

11. A computer readable medium embodying the computer program of claim 10.

12. A processor configured:
(a) to receive spectral data from a spectrometer, the spectral data comprising M discrete intensity values within one of a range of wavelength values, a range of frequency values and a range of mass values;
(b) to apply a first function to the spectral data to obtain an inverse transform of the spectrum,
(c) to zero-fill said inverse transform, and
(d) to apply a second function to the zero-filled inverse transform to obtain a spectrum comprising N discrete intensity values within said one of said ranges of wavelength, frequency and mass values, and wherein N>M.

13. A spectrometer arranged to generate an array of spectral data comprising M discrete intensity values within one of a range of wavelength values, a range of frequency values and a range of mass values, the spectrometer including the processor of claim 12.
